(19) United States
(12) Patent Application Publication
(10) Pub. No.: US 2020/0193477 A1
(43) Pub. Date: Jun. 18, 2020

(54) EXPERIENCE-BASED PEER RECOMMENDATIONS

(71) Applicant: SONY INTERACTIVE ENTERTAINMENT LLC, SAN MATEO, CA (US)

(72) Inventor: MISCHA STEPHENS, SAN MATEO, CA (US)

(21) Appl. No.: 16/220,465

(22) Filed: Dec. 14, 2018

(51) Int. Cl. G06Q 30/02; A63F 13/795

(52) U.S. Cl. CPC G06Q 30/0255; A63F 13/795; G06Q 30/0282

(57) ABSTRACT

A system and method for providing peer recommendations in a network environment are provided. At least one activity file and a corresponding content file may be stored in memory in a database. Such content file may include media content depicting the activity. One of the activity files may be received regards an activity that a user and at least one peer have participated in simultaneously on the network environment. A corresponding content file may also be received with the received activity file. A user-peer indication may be identified based on the received activity file that may identify a peer with whom the user experienced a significant event during the activity. Such user-peer indication and a portion of the media content associated with the significant even may be provided to the user.

### BACKGROUND OF THE INVENTION

### 1. Field of the Invention

The present technology pertains to peer recommendations. More specifically, the present technology may provide for experience-based peer recommendations.

### 2. Description of the Related Art

Social gaming experiences—whether competitive, team-based, or otherwise involving one's social network—are a popular segment of digital gameplay. Conventional social games may require a user to solicit peers to join their social gaming network or may suggest random peers with no common interest to the user. Typically, a user may want to add more peers to their social gaming network, but may not know which peers to add based on a common interest (e.g., style of gameplay, complementary skills, etc.) as such interests may not be readily available or immediately discernible.

Due to the popularity of social gaming, lack of peers or social interactions may detract from the user experience. For example, a user may want to play a multiplayer game with their peers, but the user may not know enough peers to fulfil a required minimum number of players. In another example, random selection of players for a multiplayer game may mismatch the peers to the user (e.g., peers with different skillsets, styles, etc.). Such mismatch of peers or lack of peers may discourage the user from continuing play of the multiplayer game.

There is, therefore, a need in the art for systems and methods for experience-based peer recommendations.

### SUMMARY OF THE PRESENTLY CLAIMED INVENTION

Embodiments of the present invention include systems and methods for providing experience-based peer recommendations in a network environment. At least one activity file and a corresponding content file may be stored in memory in a database. Such content file may include media content depicting the activity. One of the activity files may be received. Such activity file may regard an activity that a user and at least one peer have participated in simultaneously on the network environment. A corresponding content file may also be received with the received activity file. A user-peer indication may be identified based on the received activity file. Such user-peer indication may identify a peer with whom the user experienced a significant event during the activity. Such user-peer indication and a portion of the media content associated with the significant even may be provided to the user.

Various embodiments may include methods for providing peer recommendations in a network environment. Such methods may include receiving an activity file regarding an activity that a user and at least one peer have participated in simultaneously on the network environment. Such methods may include receiving a content file associated with the activity file. Such content file may include media content depicting the activity. Such methods may include identifying a user-peer indication based on the activity file. Such user-peer indication may identify a peer with whom the user experienced a significant event during the activity. Such methods may include providing the user-peer indication and a portion of the media content associated with the significant event to the user.

Additional embodiments may include systems for providing experience-based peer recommendations. Such systems may include memory that stores at least one activity file. Such memory may store at least one content file associated with each of the activity files. Such content file may include media content depicting the activity. Such system may include a processor that executes instructions stored in memory. Execution of the instructions by the processor may receive an activity file regarding an activity that a user and at least one peer have participated in simultaneously on the network environment. Execution of the instructions by the processor may receive a content file associated with the received activity file. Execution of the instructions by the processor may identify a user-peer indication based on the received activity file. Such user-peer indication may identify a peer with whom the user experienced a significant event during the activity. Execution of the instructions by the processor may provide the user-peer indication and a portion of the media content associated with the significant event to the user.

Further embodiments include non-transitory computer-readable storage media having embodied thereon a program executable by a processor to provide peer recommendations in a network environment.

### BRIEF DESCRIPTION OF THE DRAWINGS

FIG. 1 illustrates an exemplary network environment in which a system for experience-based peer recommendations may be implemented.

FIG. 2 illustrates a detailed exemplary network in which a system for binding data from a universal data system to user generated content may be implemented.

FIG. 3 is a flowchart illustrating an exemplary method for content blocking.

FIG. 4 is an exemplary electronic entertainment system that may be used in providing experience-based peer recommendations.

### DETAILED DESCRIPTION

The detailed description set forth below is intended as a description of various configurations of the subject technology and is not intended to represent the only configurations in which the technology can be practiced. The appended drawings are incorporated herein and constitute a part of the detailed description. The detailed description includes specific details for the purpose of providing a more thorough understanding of the technology. However, it will be clear and apparent that the technology is not limited to the specific details set forth herein and may be practiced without these details. In some instances, structures and components are shown in block diagram form in order to avoid obscuring the concepts of the subject technology.

Embodiments of the present invention include systems and methods for providing experience-based peer recommendations. An activity file may be stored in a database. Such activity file may include data regarding an activity that a user and at least one peer participated in together over a network environment. The activity file may be received by a server. A content file may be received by the server. Such content file may be associated with the activity file and may include media content depicting the activity. A user-peer indication may be identified by the server based on the data regarding the activity. Such user-peer indication may identify a peer that the user experienced a significant even with during the activity. The user-peer indication and a portion of the media content associated with the significant even may be provided to the user.

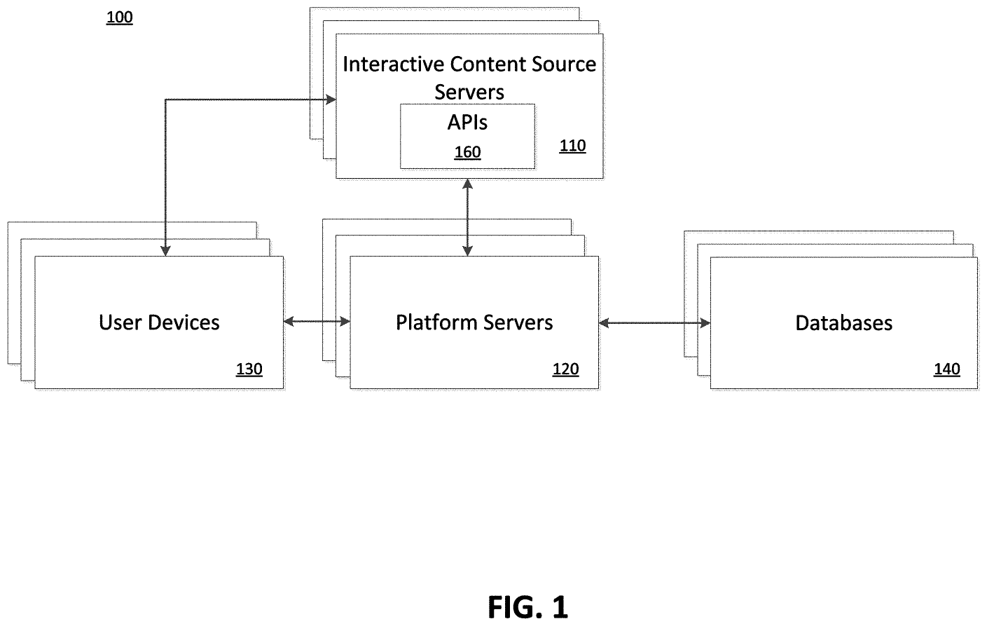

FIG. 1 illustrates an exemplary network environment 100 in which a system for providing experience-based peer recommendations can occur. The network environment 100 may include one or more interactive content source servers 110 that provide interactive content titles (e.g., games, interactive movies, interactive digital books, etc.), platform servers 120, one or more user devices 130, and one or more databases 140.

Interactive content source servers 110 may maintain and host interactive content titles (e.g., video games, interactive books, interactive movies, etc.) available for play to a user device 140 over a communication network. Such interactive content servers 110 may be implemented in the cloud (e.g., one or more cloud servers). Each interactive content title may include one or more activities available within the content title. The one or more activities may be playable by a single user or by multiple users. In one example, the interactive content title is a video game title having different modes of competitive gameplay available within that game title. In another example, the interactive content title is another video game title having an interactive storyline for single user play. Such interactive content servers 110 may also stream and capture media content (e.g., video, screenshots, commentary, audio, etc.) during a user and/or peer participation in an activity, though such content may also be captured and/or streamed by the platform servers 120.

The platform servers 120 may be responsible for communicating with the different interactive content servers 110, databases 140, and user devices 130. Such platform servers 120 may be implemented on one or more cloud servers. The interactive content servers 110 may communicate with multiple platform servers 120. The platform servers 120 may also carry out instructions, for example receiving an activity file having data regarding an activity (e.g., a quest, storyline, competitive match, boss fight, etc.) that a user and at least one peer have participated in simultaneously on the network environment. The platform servers 120 may further carry out instructions, for example, receiving a content file associated with the activity file. Such content file may include media content depicting the activity. The platform servers 120 may further carry out instructions, for identifying a user-peer indication based on the data regarding the activity. Such user-peer indication may identify a peer that the user experienced a significant event (e.g., beating a boss together, a peer saving the user's character's life, etc.) with during the activity. The platform servers 120 may further carry out instructions, for example, providing the user-peer indication and a portion of the media content associated with the significant event to the user.

The interactive content titles, streaming media, and corresponding activity information may be provided through an application programming interface (API) 160, which allows various types of interactive content servers 110 to communicate with different platform servers 120 and different user devices 130. API 160 may be specific to the particular computer programming language, operating system, protocols, etc., of the interactive content servers 110 providing the streaming media, the platform servers 120 providing the associated activity and/or object information, and user devices 130 receiving the same. In a network environment 100 that includes multiple different types of interactive content servers 110 (or platform servers 120 or user devices 130), there may likewise be a corresponding number of APIs 160.

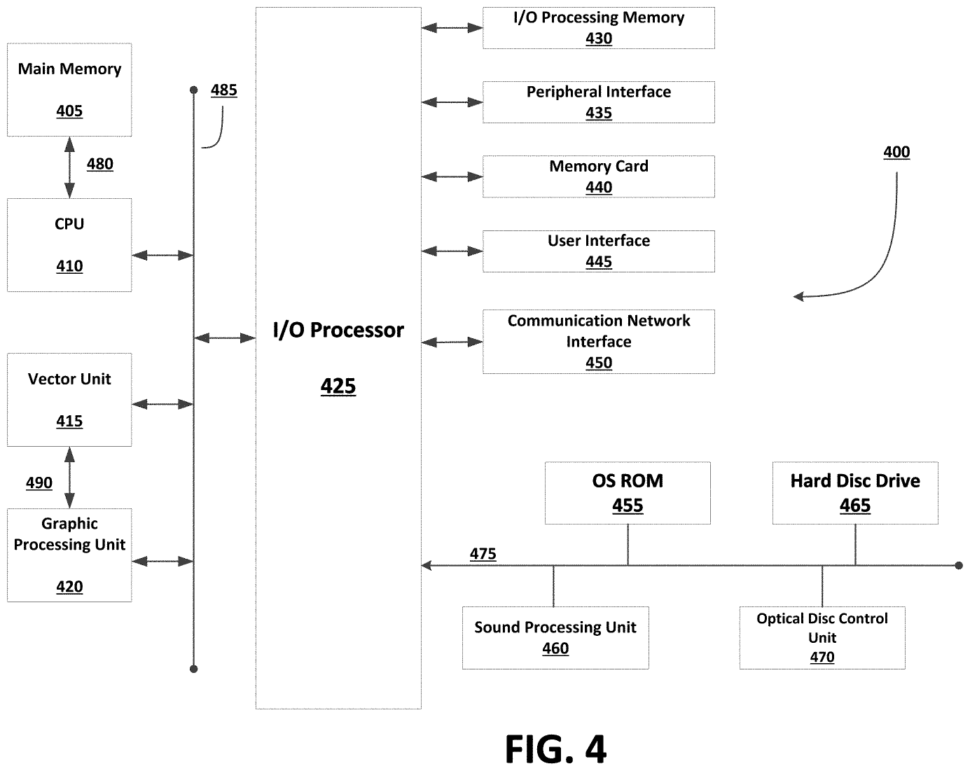

The user device 130 may include a plurality of different types of computing devices. For example, the user device 130 may include any number of different gaming consoles, mobile devices, laptops, and desktops. Such user device 130 may also be configured to access data from other storage media, such as, but not limited to memory cards or disk drives as may be appropriate in the case of downloaded services. Such devices 130 may include standard hardware computing components such as, but not limited to network and media interfaces, non-transitory computer-readable storage (memory), and processors for executing instructions that may be stored in memory. These user devices 130 may also run using a variety of different operating systems (e.g., iOS, Android), applications or computing languages (e.g., C++, JavaScript). An exemplary user device 130 is described in detail herein with respect to FIG. 4.

The databases 140 may be stored on the platform server 120, the interactive content servers 110, on the same server, on different servers, on a single server, or across different servers. Such databases 140 may store one or more interactive content titles. Such databases 140 may also store user generated content (e.g., streaming media, screen shots, commentary, videos, etc.) captured during a user and/or peer participation in an activity. Such UGC may include metadata by which to search for such media. Such UGC content may also include information about the interactive content title, user, and/or peer. Such information may be derived from data gathered during user and/or peer interaction with an activity of an interactive content title and may be “bound” to and stored with the UGC. Such binding enhances UGC as the UGC may deep link (e.g., directly launch) to an interactive content title, may provide for information about an activity and/or a peer of the UGC, and/or may allow a user to interact with the UGC.

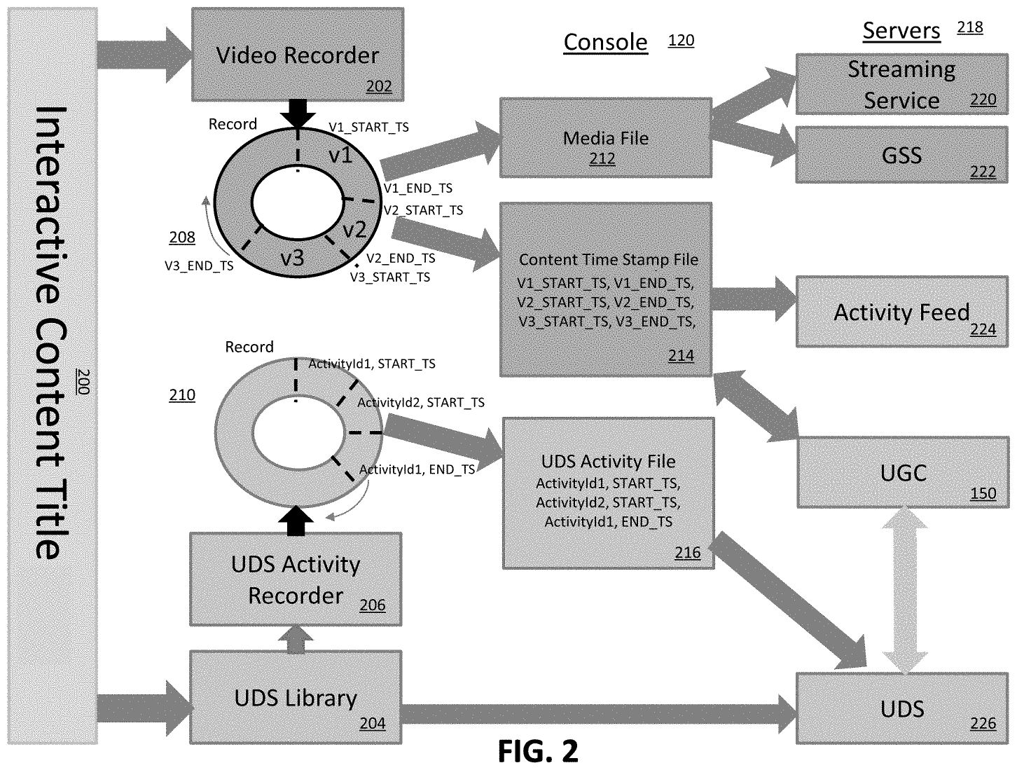

In the exemplary network environment 200 of FIG. 2, an exemplary platform server 120, and exemplary end servers (e.g., interactive content server 220, GSS 222, activity feed server 224, UGC server and database 150, and UDS server 226) are shown. In an exemplary example, a content recorder 202 receives and records content from an interactive content title 200 onto a content ring-buffer 208. Such ring-buffer 208 may store multiple content segments (e.g., v1, v2 and v3), start times for each segment (e.g., V1_START_TS, V2_START_TS, V3_START_TS), and end times for each segment (e.g., V1_END_TS, V2_END_TS, V3_END_TS). Such segments may be stored as a media file 212 (e.g., MP4, WebM, etc.) by the platform server 120. Such media file 212 may be uploaded to the interactive content server 220 and/or the GSS 222 for storage. Such start times and end times for each segment may be stored as a content time stamp file 214 by the platform server 120. Such content time stamp file 214 may also include a streaming ID or GSS ID to link the content time stamp file 214 to the media file 212. Such sontent time stamp file 214 may be uploaded and stored to the activity feed server 224 and/or the UGC server and database 150.

Meanwhile, a UDS Activity recorder 206 receives and records activity data from a UDS library 204 onto a UDS ring-buffer 210 (e.g., ActivityID1, START_TS; ActivityID2, START_TS; ActivityID3, START_TS). Such UDS library 204 receives data from the interactive content title 200 and may transmit data to the UDS Activity recorder 206 when an activity occurs and/or transmit data to a UDS server 226. Such activity data can be stored in a UDS activity file 216 by the platform server 120. Such UDS activity file 216 may also include activity start times, activity end times, an activity ID, activity results, activity types (e.g., competitive match, quest, task, etc.), user or peer data related to the activity. For example, a UDS activity file 216 may store data regarding an item used during the activity.

Such UDS activity data may be associated with the content data. In one example, the UGC server 150 stores the content time stamp file 214. The UGC server 150 can associated the File 214 with the media file 212 by the streaming ID or GSS ID stored with the file 214. The UGC server 150 can also communicate with the UDS server 226 to query for a UDS activity file 216 that matches the content time stamp file 214. Such query can search by matching start time and end time of the content time stamp file 214 with the start time and end time of a corresponding UDS activity file 216. Such query can also search for a match between the activity ID stored with the UDS activity file 216 and the GSS ID or streaming ID of the content time stamp file 214. Such UDS activity file 216 may be associated with the matched content time stamp file 214 by the UGC server 150. In another example, a UDS activity file 216 and a content time stamp file 214 are associated by the platform server 120 during creation of each file 214, 216.

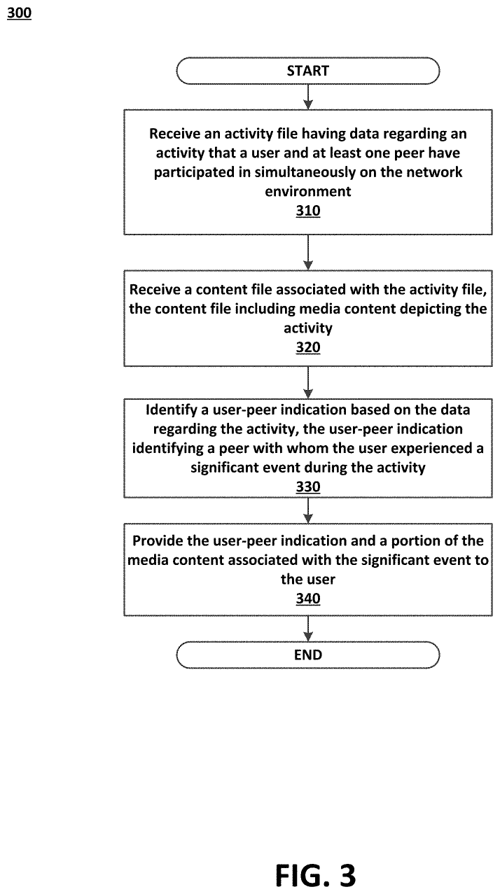

FIG. 3 is a flowchart illustrating an exemplary method 300 for providing experience-based peer recommendations. The method 300 of FIG. 3 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The execution of the instructions may be implemented on the cloud servers (e.g., the steps identified in FIG. 3 are performed in the cloud). The steps identified in FIG. 3 (and the order thereof) are exemplary and may include various alternatives, equivalents, or derivations thereof including but not limited to the order of execution of the same.

In step 310, an activity file (e.g., UDS Activity File 216) having data regarding an activity that a user and at least one peer have participated in simultaneously on the network environment 100 is received by the platform server 120 or the interactive content servers 110. Such activity file may include information about the activity (e.g., activity start times, activity end times, an activity ID, activity results, activity types (e.g., competitive match, quest, task, etc.), and user or peer data related to the activity). Such activity may be part of a gaming environment. Each activity file may also include a direct link to the associated activity. Such link allows a user to access an activity from media content. For example, a user may wish to participate in an activity shown by the media content. In the same example, the user can select an option to play the activity, and the activity may be automatically launched after selection by the user. Alternatively, the activity file may block the user from accessing the activity if the user does not own the interactive content title and may prompt the user to purchase such title.

In step 320, a content file is received by the platform server 120 or the interactive content servers 110. Such content file may be associated with the activity file. Such media content may include a media file having a plurality of time stamps (i.e., content time stamp file 214) associated with the media content. The media content may also include at least one activity file having a corresponding plurality of time stamps (i.e., UDS activity file 216). Such media content may be capture at the same time as the activity file and stored with the activity file, though the media content may be stored elsewhere. The media content may be UGC generated by the user and/or peers during participation in the activity.

In step 330, a user-peer indication is identified by the platform server 120 or the interactive content servers 110. Such user-peer indication may be based on the data regarding the activity. Such user-peer indication may identify a peer that the user experienced a significant event (e.g., defeating a boss together, finding a rare item together, experiencing a twist in a storyline) with at least one peer during participation in the activity. Such significant event may be flagged or marked by the platform server 120. For example, a time stamp (e.g., a UDS activity file 216) indicating a start of the significant event and another time stamp indicated an end of the significant event may be stored by the platform server 120. Further, such time stamp may associate the significant event with media captured during participation by the user and/or peer in the activity by matching the time stamp of the significant event to a time stamp captured with the media (e.g., a content time stamp file 214).

Such user-peer indication may be further based on a relationship between the user and peer within or outside of the network environment 100. For example, a third party account of the user may indicate that the user has a relationship with the peer outside of the network environment (e.g., the user and peer are related, enrolled in the same school, have mutual friends, etc.). In another example, the user and the peer may have participated in previous activities together and/or have previously communicated with each other within the network environment 100. Such user-peer indication may also be based on similarities between the user and the peer (e.g., similar skill level, character levels, interactive content titles, geographical location, etc.) In one example, the user and peer may own the same interactive content title and/or live within a predetermined distance from each other. In yet another example, the user and peer may participate in the same types of activities across different interactive content titles, thus suggesting that the user and peer enjoy similar types of activities.

In step 340, the user-peer indication and a portion of the media content associated with the significant event is provided to the user device 130 by the platform server 120 or the interactive content servers 110. Such portion of the media content may depict the entire significant event or may only show a clip or screenshot of the significant event. Providing the media content with the user-peer indication may remind the user of the user's experience with the peer, which may incentive the user to accept the recommendation. For example, the media content may depict a character of the peer saving a character of the user, which may be of significance to the user. As previously described, the media content may include a link to the activity depicted. Such link may allow the user to automatically launch the activity depicted. Such link may further send a notification and/or invitation to one or more peers depicted in the activity that the user is beginning participation in the activity. Such one or more peers may have been recommended to the user.

Such user-peer indication and portion of the media content may be blocked by the user. Such blocking may occur if a user has selected a user setting that may block all recommendations or may block some recommendations based on certain criteria (e.g., the user and the peer do not have any mutual peers in common, the user and the peer do not have a relationship outside of the network environment 100, the peer does not have a skillset desired by the user, etc.). For example, the user may only wish to receive peer recommendations if the peer owns two or more of the same interaction content titles. In another example, the user may only wish to receive peer recommendations from peers that the user knows personally outside of the network environment 100. As such, the user may further customize identification of a peer recommendation.

Systems and methods for experience-based peer recommendations may enhance a user experience by providing targeted peer suggestions for a user to add to their selected peer list (i.e., a friends list). Providing experience-based peer recommendations filters out many peers that a user would likely not have any commonality with and presents peers that a user has already experienced a significant and/or meaningful event with. Further, experience-based peer recommendations may provide a peer that matches the user's skills and/or style and may incentivize each player to continue participation in an interactive content title or other similar title.

FIG. 4 is an exemplary user electronic entertainment system that may be used in providing experience-based peer recommendations. The entertainment system 400 of FIG. 4 includes a main memory 405, a central processing unit (CPU) 410, vector unit 415, a graphics processing unit 420, an input/output (I/O) processor 425, an I/O processor memory 430, a peripheral interface 435, a memory card 440, a Universal Serial Bus (USB) interface 445, and a communication network interface 450. The entertainment system 400 further includes an operating system read-only memory (OS ROM) 455, a sound processing unit 460, an optical disc control unit 470, and a hard disc drive 465, which are connected via a bus 475 to the I/O processor 425.

Entertainment system 400 may be an electronic game console. Alternatively, the entertainment system 400 may be implemented as a general-purpose computer, a set-top box, a hand-held game device, a tablet computing device, a virtual reality device, an augmented reality device, or a mobile computing device or phone. Entertainment systems may contain more or less operating components depending on a particular form factor, purpose, or design.

The CPU 410, the vector unit 415, the graphics processing unit 420, and the I/O processor 425 of FIG. 4 communicate via a system bus 485. Further, the CPU 410 of FIG. 4 communicates with the main memory 405 via a dedicated bus 480, while the vector unit 415 and the graphics processing unit 420 may communicate through a dedicated bus 490. The CPU 410 of FIG. 4 executes programs stored in the OS ROM 455 and the main memory 405. The main memory 405 of FIG. 4 may contain pre-stored programs and programs transferred through the I/O Processor 425 from a CD-ROM, DVD-ROM, or other optical disc (not shown) using the optical disc control unit 470. I/O Processor 425 of FIG. 4 may also allow for the introduction of content transferred over a wireless or other communications network (e.g., 4G, LTE, 1G, and so forth). The I/O processor 425 of FIG. 4 primarily controls data exchanges between the various devices of the entertainment system 400 including the CPU 410, the vector unit 415, the graphics processing unit 420, and the peripheral interface 435.

The graphics processing unit 420 of FIG. 4 executes graphics instructions received from the CPU 410 and the vector unit 415 to produce images for display on a display device (not shown). For example, the vector unit 415 of FIG. 4 may transform objects from three-dimensional coordinates to two-dimensional coordinates, and send the two-dimensional coordinates to the graphics processing unit 420. Furthermore, the sound processing unit 460 executes instructions to produce sound signals that are outputted to an audio device such as speakers (not shown). Other devices may be connected to the entertainment system 400 via the USB interface 445, and the communication network interface 450 such as wireless transceivers, which may also be embedded in the system 400 or as a part of some other component such as a processor.

A user of the entertainment system 400 of FIG. 4 provides instructions via the peripheral interface 435 to the CPU 410, which allows for use of a variety of different available peripheral devices (e.g., controllers) known in the art. For example, the user may instruct the CPU 410 to store certain game information on the memory card 440 or other non-transitory computer-readable storage media or instruct a character in a game to perform some specified action.

The present invention may be implemented in an application that may be operable by a variety of end user devices. For example, an end user device may be a personal computer, a home entertainment system (e.g., Sony PlayStation2® or Sony PlayStation3® or Sony PlayStation4®), a portable gaming device (e.g., Sony PSP® or Sony Vita®), or a home entertainment system of a different albeit inferior manufacturer. The present methodologies described herein are fully intended to be operable on a variety of devices. The present invention may also be implemented with cross-title neutrality wherein an embodiment of the present system may be utilized across a variety of titles from various publishers.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method of providing peer recommendations in a network environment, the method comprising:
receiving an activity file regarding an activity that a user and at least one peer have participated in simultaneously on the network environment;
receiving a content file associated with the activity file, the content file including media content depicting the activity;
identifying a user-peer indication based on the activity file, the user-peer indication identifying a peer with whom the user experienced a significant event during the activity; and
providing the user-peer indication and a portion of the media content associated with the significant event to the user.

2. The method of claim 1, wherein the activity occurs within a gaming environment.

3. The method of claim 2, wherein the significant event is one of a boss fight, match competition, and quest.

4. The method of claim 1, wherein the media content is one of a streaming video, commentary, and screenshot.

5. The method of claim 1, wherein the user-peer indication is further based on a third-party account of the user indicating that the user has a pre-existing relationship with the peer.

6. The method of claim 1, further comprising receiving a notification that the user-peer indication has been blocked by the user.

7. The method of claim 6, wherein the blocked user-peer indication is based on the user and the peer having no mutual peers in common.

8. A system for providing peer recommendations in a network environment, the system comprising:
memory that stores:
at least one activity file, and
at least one content file, each content file associated with one of the activity files, the content file including media content depicting the activity; and
a processor that executes instructions stored in memory, wherein execution of the instructions by the processor:
receives an activity file regarding an activity that a user and at least one peer have participated in simultaneously on the network environment,
receives a content file associated with the received activity file,
identifies a user-peer indication based on the received activity file, the user-peer indication identifying a peer with whom the user experienced a significant event during the activity, and
provides the user-peer indication and a portion of the media content associated with the significant event to the user.

9. The system of claim 8, wherein the activity occurs within a gaming environment.

10. The system of claim 9, wherein the significant event is one of a boss fight, match competition, and quest.

11. The system of claim 8, wherein the media content is one of a streaming video, commentary, and screenshot.

12. The system of claim 8, wherein the user-peer indication is further based on a third-party account of the user indicating that the user has a pre-existing relationship with the peer.

13. The system of claim 8, wherein further execution of the instructions by the processor receives a notification that the user-peer indication has been blocked by the user.

14. The system of claim 13, wherein the blocked user-peer indication is based on the user and the peer having no mutual peers in common.

15. A non-transitory computer-readable medium having embodied thereon a program executable by a processor to provide a method of providing peer recommendations in a network environment, the method comprising:
receiving an activity file regarding an activity that a user and at least one peer have participated in simultaneously on the network environment;
receiving a content file associated with the activity file, the content file including media content depicting the activity;
identifying a user-peer indication based on the activity file, the user-peer indication identifying a peer with whom the user experienced a significant event during the activity; and
providing the user-peer indication and a portion of the media content associated with the significant event to the user.
